(19) United States
(12) Patent Application Publication
(10) Pub. No.: US 2017/0312909 A1
(43) Pub. Date: Nov. 2, 2017

(54) SAWHORSE

(71) Applicant: KETER PLASTIC LTD., Herzelyia (IL)

(72) Inventor: Yaron BRUNNER, Kibbutz Gvat (IL)

(73) Assignee: KETER PLASTIC LTD., Herzelyia (IL)

(21) Appl. No.: 15/520,569

(22) PCT Filed: Oct. 22, 2015
(86) PCT No.: PCT/IL2015/051043

§ 371 Date: Apr. 20, 2017

Related U.S. Application Data
(60) Provisional application No. 62/067,579, filed on Oct. 23, 2014.

(51) Int. Cl. B25H 1/16; B25H 1/06

(52) U.S. Cl. CPC B25H 1/16; B25H 1/06

(57) ABSTRACT

Provided is a sawhorse including two rigid frame members pivotally articulated to one another. Each frame member includes two legs wherein at least one leg of each frame member is an extendible leg including a support leg portion, an extension member coaxially extending therewithin and a locking mechanism actuatable by one or more manipulation member. The extension member is displaceable between a fully retracted position and a fully extracted position. The arrangement is such that extraction of the extension member is facilitated without requiring manipulation of the manipulation member actuating the locking mechanism while the retraction displacement of the extension member is facilitated only upon manipulating the manipulation member to actuate the locking mechanism to thereby allow retraction of the extension member into the support leg portion.

### TECHNOLOGICAL FIELD

The present disclosed subject matter is generally in the field of DIY (do it yourself) and more particularly it is concerned with a sawhorse.

### BACKGROUND ART

References considered to be relevant as background to the presently disclosed subject matter are listed below:
U.S. Pat. No. 6,164,413
U.S. Pat. No. 6,712,180
U.S. Pat. No. 6,209,683

Acknowledgement of the above references herein is not to be inferred as meaning that this is in any way relevant to the patentability of the presently disclosed subject matter.

### BACKGROUND

Various types of height adjustable sawhorses are known in the art. Some of the sawhorses provide for a possibility of adjusting the height of one or all of the support legs of the sawhorses to the respective regular or irregular surfaces. For example, U.S. Pat. No. 6,164,413 is directed to a sawhorse which provides for supporting workpieces while being worked. The sawhorse includes a pair of sides which are joined at their upper ends for supporting the workpiece and which diverge at their lower ends for stable support of the sawhorse and the workpiece thereon on a horizontal supporting surface, characterized in that the lower end of each of the sides includes a vertically-adjustable extension for adjusting the height of the sawhorse.

U.S. Pat. No. 6,209,683 is directed to a sawhorse which includes an upper cross member having two ends. A pair of legs is hingedly connected to each end of the upper cross member. Each leg has an upper portion and a lower portion slidingly received by the upper portion. Each leg is therefore independently adjustable in length. There is a latch mechanism on each leg for releasibly latching the upper and lower portion of each leg together. A plurality of spaced-apart steps extend between the legs on each side of the sawhorse. The steps are parallel to the upper cross member. At least one of the steps is removable. Preferably at least one of the steps is removably connected to the lower portions of the legs.

U.S. Pat. No. 6,712,180 is directed to a sawhorse which includes an elongated workpiece supporting structure and a pair of leg assemblies joined to the workpiece supporting structure, which enables the leg assemblies to be moved between a folded position for storage and transportation purposes and an operative position. The connecting structure connects the leg assemblies to retain the leg assemblies in the operative position thereof and to allow movement of the leg assemblies between the operative and folded positions thereof. Each leg assembly includes a pair of separate lower leg members and is mounted for independent movement in a generally vertical direction and adjusted to a plurality of different positions with respect to the associated leg assembly and the connecting structure while the pair of the leg assemblies are retained in the operative position thereof by the connecting structure. A releasable locking member for each leg member is mounted in the connecting structure for movement between a releasing position and a locking position.

### General Description

According to the present disclosure there is disclosed a DIY sawhorse comprising two rigid frame members pivotally articulated to one another, each frame member comprising two legs wherein at least one leg of each frame member is an extendible leg comprising a locking mechanism and an extension member displaceable between a fully retracted position and a fully extracted position; wherein retraction displacement of the extension member can be facilitated only upon unlocking the locking mechanism.

In accordance with an aspect of the disclosed subject matter there is provided a sawhorse comprising two rigid frame members pivotally articulated to one another, each frame member comprising two legs wherein at least one leg of each frame member is an extendible leg comprising a support leg portion, an extension member coaxially extending therewithin and a locking mechanism actuatable by one or more manipulation member, the extension member being displaceable between a fully retracted position and a fully extracted position; wherein extraction of the extension member is facilitated without requiring manipulation of the manipulation member configured for actuating the locking mechanism while the retraction displacement of the extension member is facilitated only upon manipulating the manipulation member to actuate the locking mechanism to thereby allow retraction of the extension member into the support leg portion.

According to a particular configuration the two frame members of the sawhorse are pivotally articulated to one another at their top portions, establishing together at least one utility portion, said sawhorse disposable between a collapsed/folded position, at which the frames are substantially disposed and adjoin one another, and an open position at which the sawhorse assumes an inverted V-like shape.

The term utility portion as used herein in the specification and claims defines any sort of arrangement configured for supporting a workspace and the like. For example, a utility portion can be a flat surface (e.g. for supporting a board of material) or a notch configured for supporting an elongate workpiece (being for example a V-notch, a right-angled notch, a semicircular notch and the like).

Any one or more of the following designs, features and configurations can be applied with the sawhorse of the present disclosure, separately or in various combinations thereof:
The locking mechanism, is configured such that the gravity force acting on the extension member is lesser than friction forces extending between the extension member and the support leg portion, including such forces resulting from the locking mechanism such that the extension member is prevented for spontaneously displacing into extracted configuration, unless an external force is applied in an extraction direction;
All legs of the sawhorse can be configured with an extendible leg;
Extending an extendible leg, namely extraction displacement of an extension member can be facilitated spontaneously, i.e. without unlocking the locking mechanism;
The extendible leg is telescopic, wherein the extension member is coaxially displaceable with respect to a support leg portion of the frame;
The arrangement can be configured such that the gravity force acting on the extension member is lesser than friction forces extending between the extension member and the support leg portion, including such forces resulting from the locking mechanism. The arrangement thus being such that an extension member will not spontaneously displace into extraction, unless an external force is applied in the extraction direction. Such an external force can be, for example, a pulling force applied to the extension member in extraction direction;
The locking mechanism comprises at least one locking member associated with the respective extendible leg and a locking lever/bolt member configured to engage the locking member;
The locking mechanism is configured to facilitate axial displacement of the extension member with respect to the support leg portion in an extracting sense, whilst retraction (i.e. in an opposite sense) can be facilitated only upon unlocking the locking mechanism;
The locking mechanism can be a ratchet type locking mechanism;
The locking mechanism can be an eccentric/cam type lock;
The locking mechanism can be configured with a biasing mechanism for retaining the locking mechanism at a normally locked position;
The biasing mechanism is integrally formed with at least a portion of the locking mechanism;
The biasing mechanism is a biasing spring configured contract and biased to expand;
The locking mechanism comprises a lever (or a bolt) associated with a locking member provided over each of the extendable legs and wherein the two legs of at least one of the frame members are extendible legs having a locking mechanism actuatable by a common manipulating member;
the two levers (or bolts) associated with the locking members of the two extendable legs are configured with a biasing mechanism for retaining the locking mechanism at a normally locked position; Retraction displacement of the extension member can be facilitated also when the locking mechanism is at its locked position, whereby the locking mechanism will spontaneously displace into its unlocked position (the term spontaneously in this sense suggests that no manipulation of the locking mechanism is required by a user);
Where two legs of a frame member are extendible legs, a common unlocking lever or a bolt can be configured for simultaneous unlocking of the two respective locking mechanisms;
The legs of a first frame are disposed between the legs of a second frame; according to a particular design at the collapsed (folded position) portions of the legs of the first frame can partially overlap portions of the legs of the second frame;
The extendible legs can be configured with indicia for indicating the extent of axial displacement of the extension member with respect to the support leg portion;
The sawhorse comprises one or more bubble levels for determining a level position of the sawhorse;
One or more shelves can be articulated to the frames and be disposable between a collapsed/folded position, at which the one or more shelves are substantially stowed between the folded frames, and an open position at which the one or more shelves are disposed substantially horizontally between the two frames;
At the folded position of the sawhorse, the carrying handle can be disposed below the top portions of the pivoted frames. At the folded position, two or more sawhorses can be carried with one hand extending through coextendingly disposed handles of adjoining sawhorses;
A shelf can be configured with one or more carrying handles (e.g. in the form of openings) configured for carrying the sawhorse at its folded position;
The frames can be configured as I-like frames with or without an interconnecting top portion facilitating pivotal articulation of the two frames to one another;
Bottom ends of the legs can be configured with floor engaging members. Floor engaging members can be configured with anti skid surfacing, with ground securing portions and with a pulling foot portion whereby an individual can apply pulling force to the extension member so as to facilitate its extraction from the support leg portion (thereby overcoming friction forces and biasing forces of the locking mechanism);
Pivotal articulation of the top portions of the two frame members can be facilitated by a first frame member configured with a tubular receptacle coaxially receiving therein a corresponding pivoting segment of the second frame member, said pivoting segment configured for snug rotation within the tubular receptacle;
The top portion of the sawhorse can be configured with a tubular opening extending along a pivot axis of the sawhorse.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A is a front perspective view of a sawhorse according to the present disclosure, at an open position and with retracted legs;

FIG. 1B is a rear side perspective view of the sawhorse of FIG. 1A;

FIG. 1C is a right side view of the sawhorse of FIG. 1A;

FIG. 1D is a right side view of the sawhorse of FIG. 1A, however at its closed/collapsed position;

FIG. 1E is a front view of the sawhorse of FIG. 1D;

FIGS. 2A to 2G are enlargements of various portions of the sawhorse of FIG. 1A;

FIG. 3A is a primary exploded view of the sawhorse of FIG. 1A;

FIG. 3B is a secondary exploded view of a first frame member of the sawhorse of FIG. 1A;

FIG. 3C is a secondary exploded view of a second frame member of the sawhorse of FIG. 1A;

FIGS. 4A and 4B are a front and a rear perspective view the sawhorse, at a collapsed position and with the legs retracted, respectively;

FIG. 4C is a section taken along line IV-IV in FIG. 4A;

FIG. 4D is a top planer view of the portion marked V in FIG. 4C;

FIG. 5A is a schematic representation of a locking mechanism according to one configuration;

FIG. 5B is a modification of the locking mechanism illustrated in FIG. 5;

FIG. 5C is a schematic representation of a locking mechanism according to another configuration;

FIGS. 6A and 6B are a front and a rear perspective view respectively, of the sawhorse, at an open position and with all four legs extracted;

FIGS. 7A to 7C illustrate different modes of use of the sawhorse;

FIGS. 8A to 8E are perspective views illustrating consecutive steps of folding and carrying a sawhorse according to the present disclosure;

FIGS. 9A to 9E illustrate a sawhorse and a respective locking mechanism in accordance with another example of the disclosed subject matter; and

FIGS. 10A and 10B illustrate a locking mechanism in accordance with another example of the disclosed subject matter, in its operative and resting positions.

### DETAILED DESCRIPTION OF EMBODIMENTS

Attention is directed to drawings illustrating a sawhorse according to the present disclosure, generally designated 10. The sawhorse 10 is composed of a first frame 12 and a second frame 14 pivotally articulated to one another at their top, as will be discussed hereinafter in greater detail.

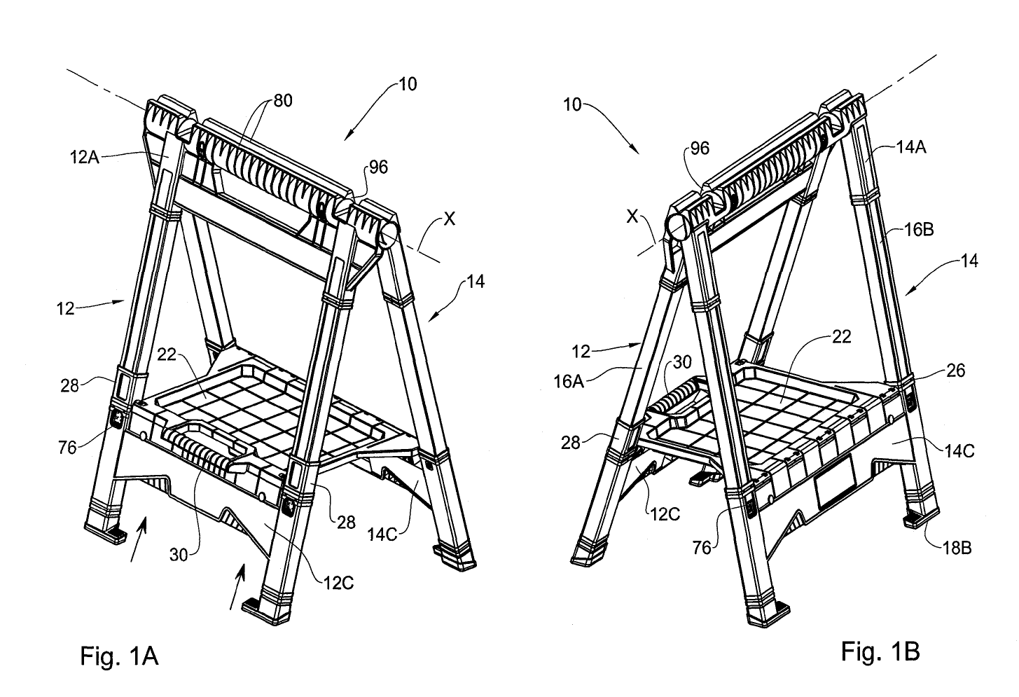

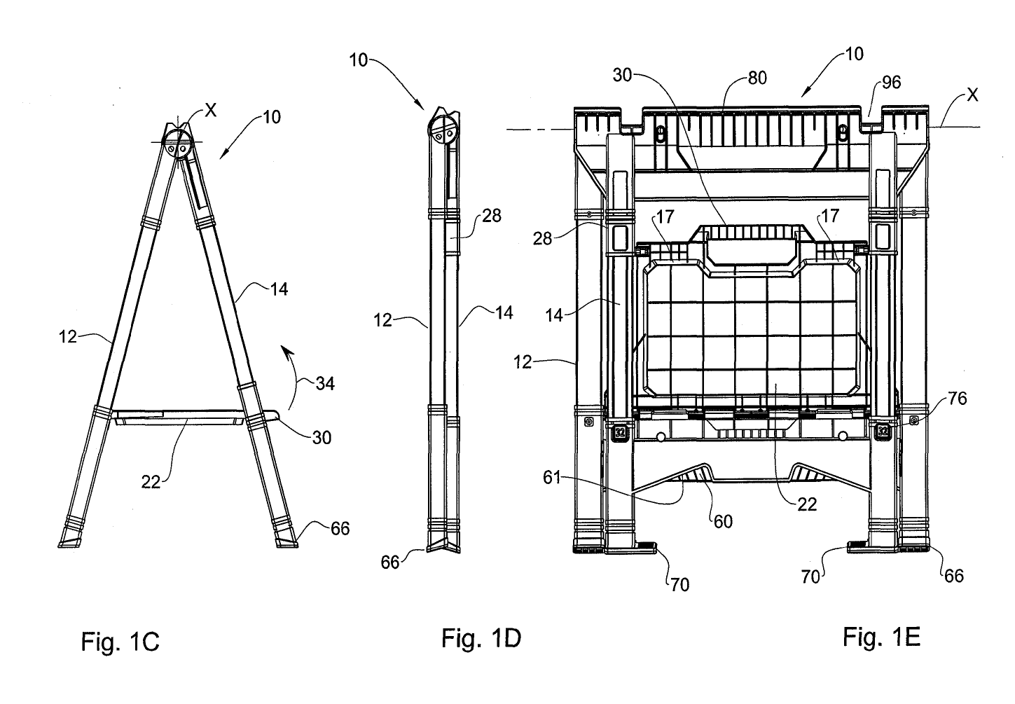

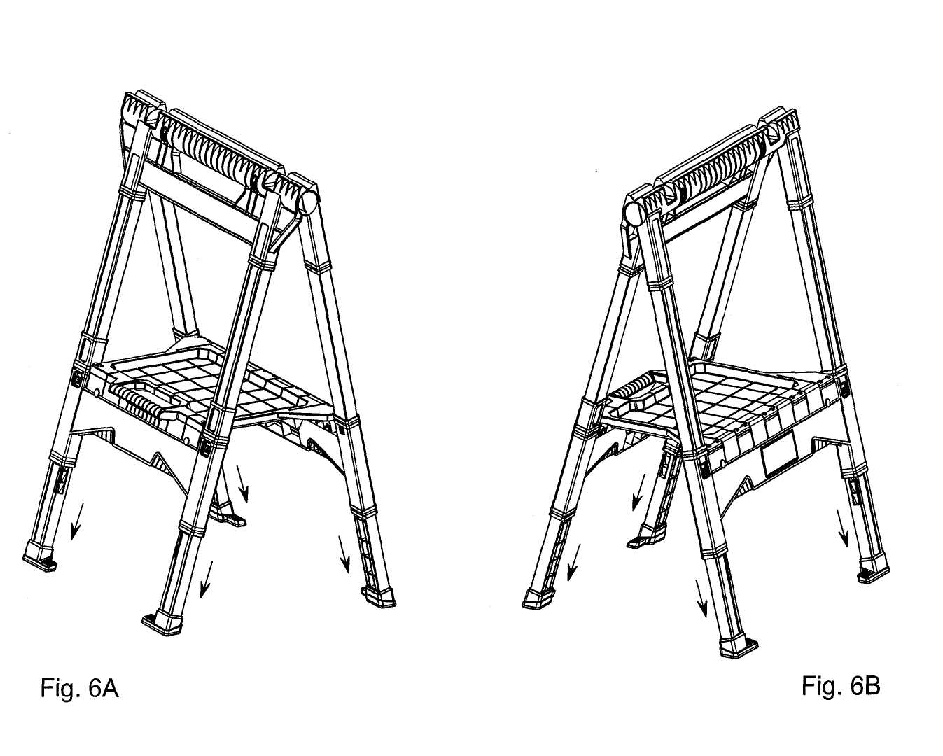

The frames 12 and 14 have a general H-like shape (though the first frame 12 has an interconnecting top portion). Each frame comprises a top portion 12A and 14A respectively, a pair of legs 12B and 14B, and interconnecting support member 12C and 14C. Each leg 12B and 14B is configured with a support leg portion 16A and 16B articulated to the top portion) and an extension leg member 18A and 18B, respectively. The arrangement is such that the support leg portions 16A and 16B have a rectangle cross-section and each extension leg member 18A and 18B has a corresponding rectangular cross-section and are thus configured for snug coaxial displacement (i.e. retraction/extraction between a fully retracted position as in FIGS. 1A and 1B, and a fully extracted position as in FIGS. 6A and 6B). It is however appreciated that the legs can be telescopic and configured with other cross-sectional shapes and further, each extension leg member 18A and 18B is independently axially displaceable with respect to the respective support leg portions 16A and 16B.

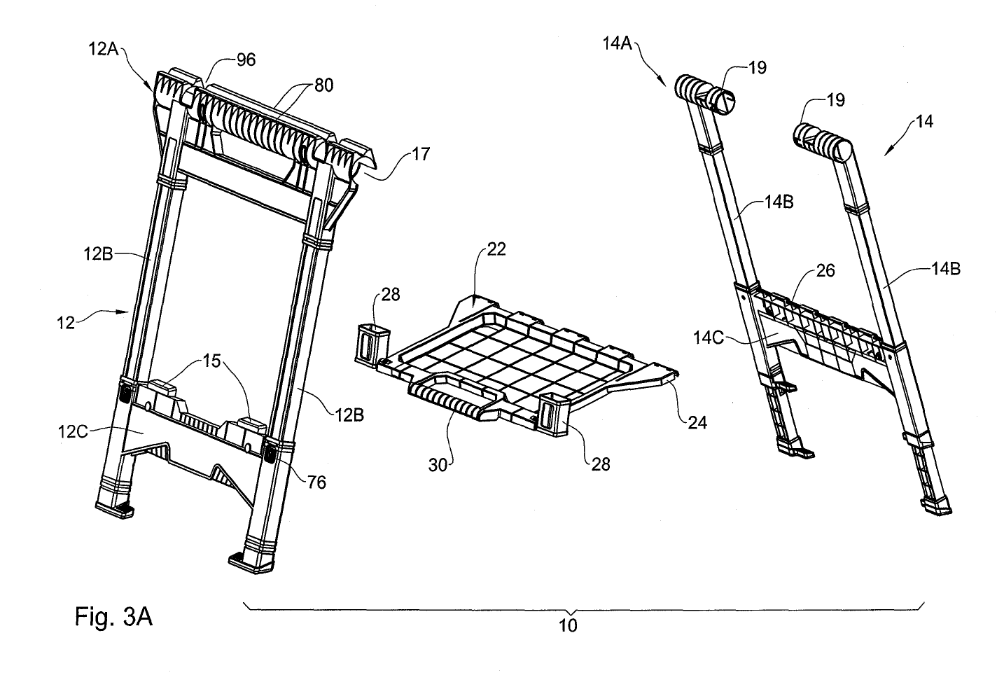

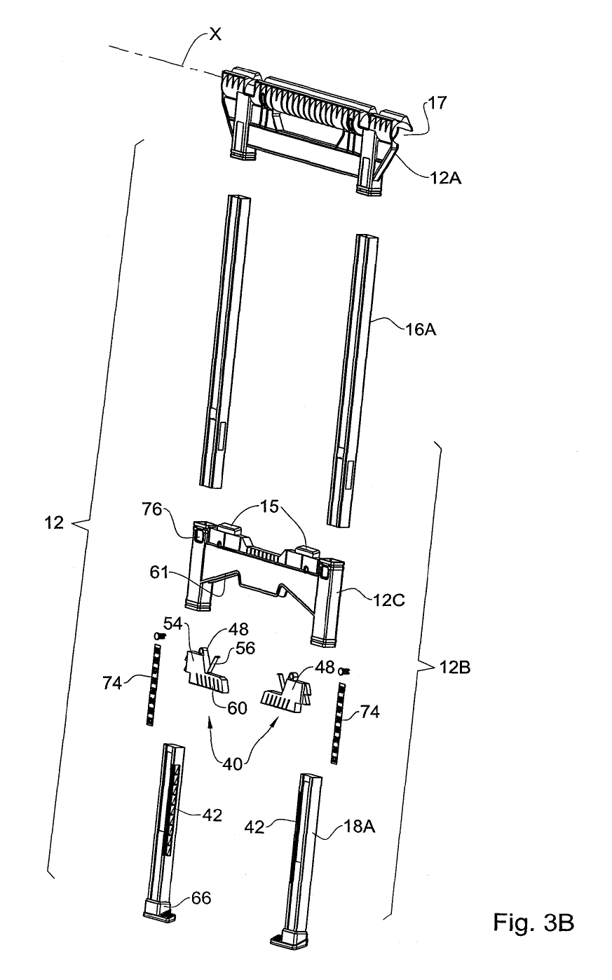

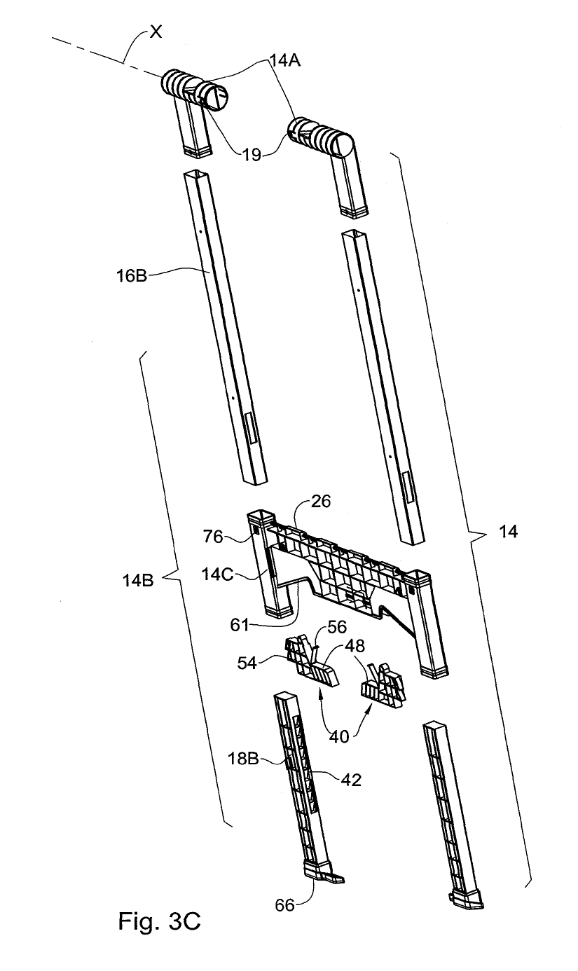

In the particular example, pivotal articulation of the two frames 12 and 14 at their respective top portions is facilitated by a tubular receptacle 17 (FIGS. 3A and 3B) of the first frame member 12 coaxially receiving therein a corresponding pivoting tubular segment 19 of the second frame member 14, said pivoting segment configured for snug rotation within the tubular receptacle, giving rise to a tubular opening extending along a pivot axis X of the sawhorse.

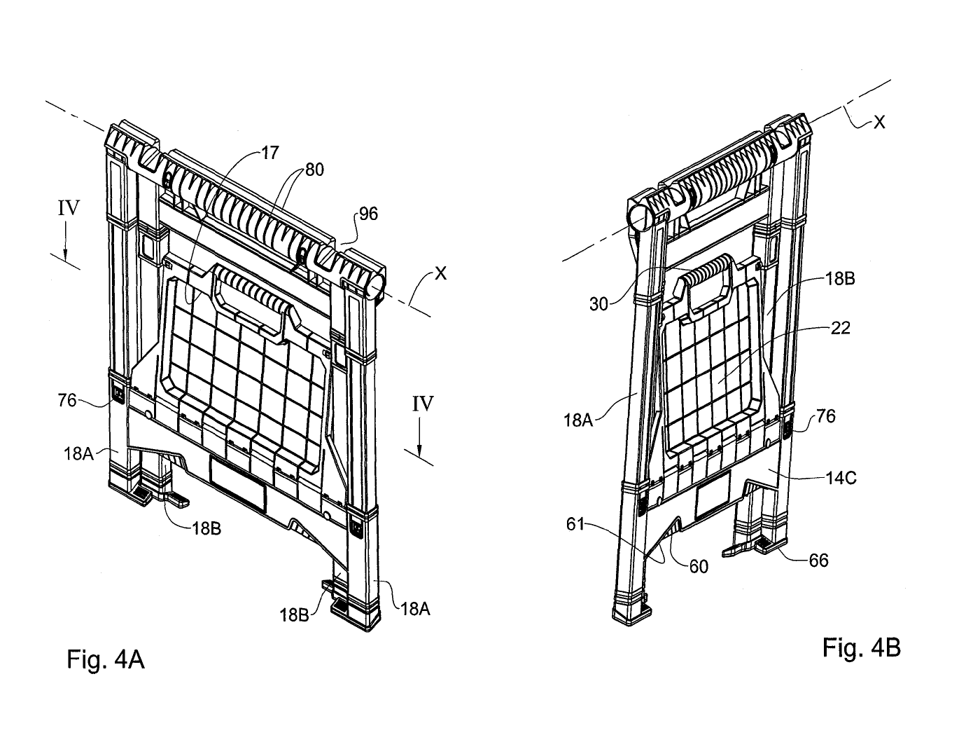

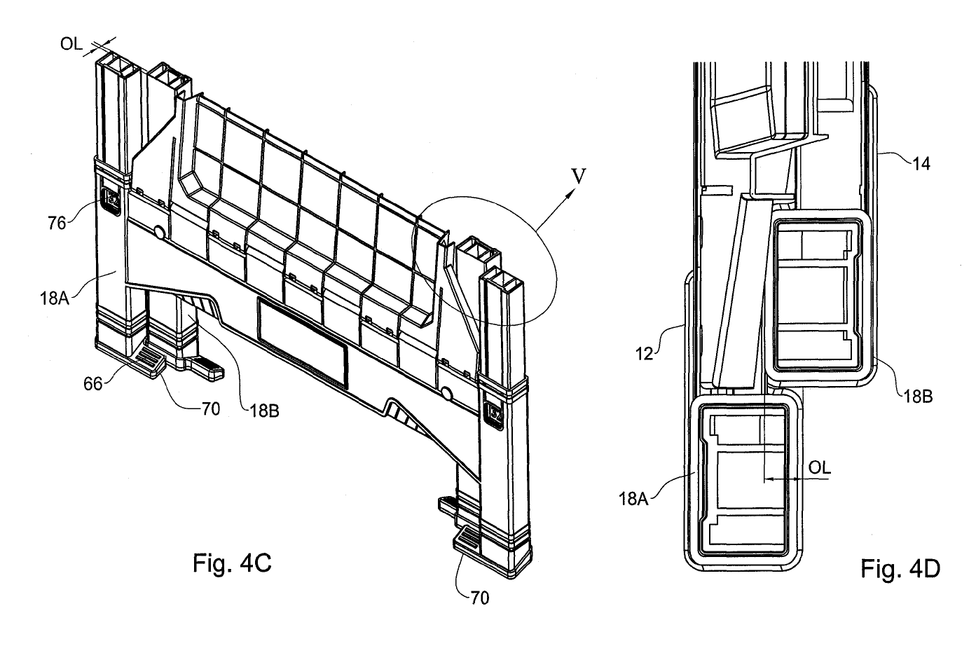

The sawhorse 10 is further configured with a collapsible shelf 22 pivotally articulated at hinge axis 24 to axis 26 of the second frame 14, and slidingly articulated to the first frame 12 by a pair of sliders 28 slidingly displaceable over the support leg portions 16A. It is seen that at the fully deployed position (FIGS. 1A and 1B), the shelf 22 is substantially horizontally disposed between the frames 12 and 14 and increasing the stability of the sawhorse. At the collapsed state (e.g. FIGS. 4A and 4B), the shelf 22 is substantially vertical and does not project from the frames (best seen in FIGS. 1D and 1E), rendering it compact for storage and shipment.

The shelf 22 is further configured with a carrying handle 30 which in the present example, at the open position of the sawhorse 10, slightly projects beyond the first frame 12 (best noted in FIG. 1C). This arrangement is useful in folding the sawhorse whereby applying an upward (pivotal) push to the handle 30 in the direction of arrow 34 (FIG. 1C) assists in collapsing the sawhorse 10.

It is further noted that the interconnecting support member 12C of the first frame 12 is configured with upwardly projecting arresting members 15 (FIG. 3A) and the shelf 22 is configured at a bottom face thereof with corresponding arresting depressions 17 (FIG. 1E), whereby upon deploying the sawhorse 10 into its open position said depressions 17 engage over and arrest the arresting members 15, increasing stability of the sawhorse at its open position and facilitating for mounting heavy loads over the shelf 22 and the sawhorse.

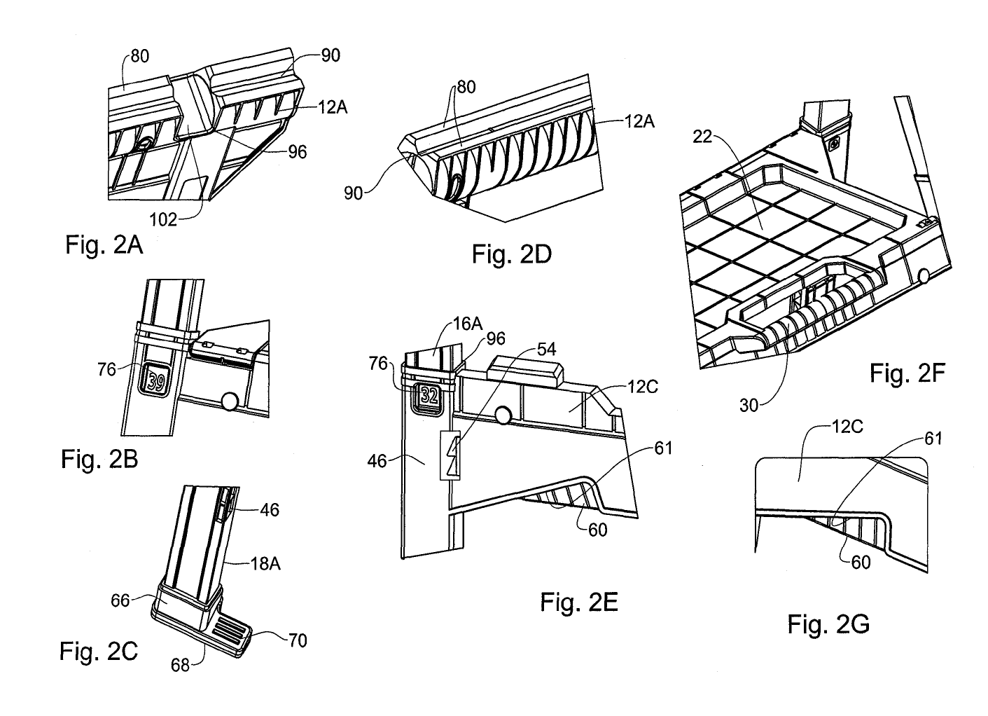

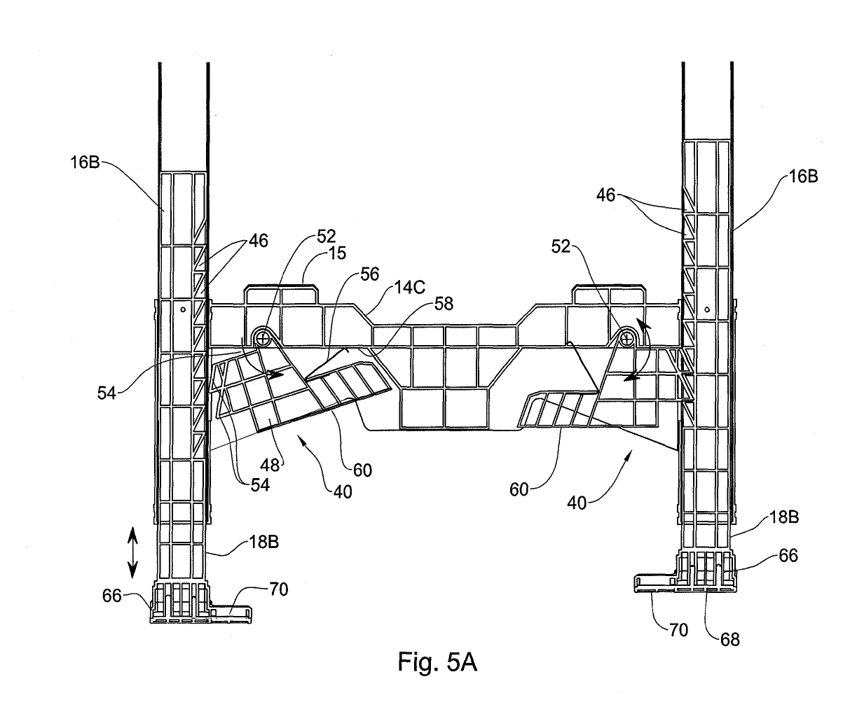

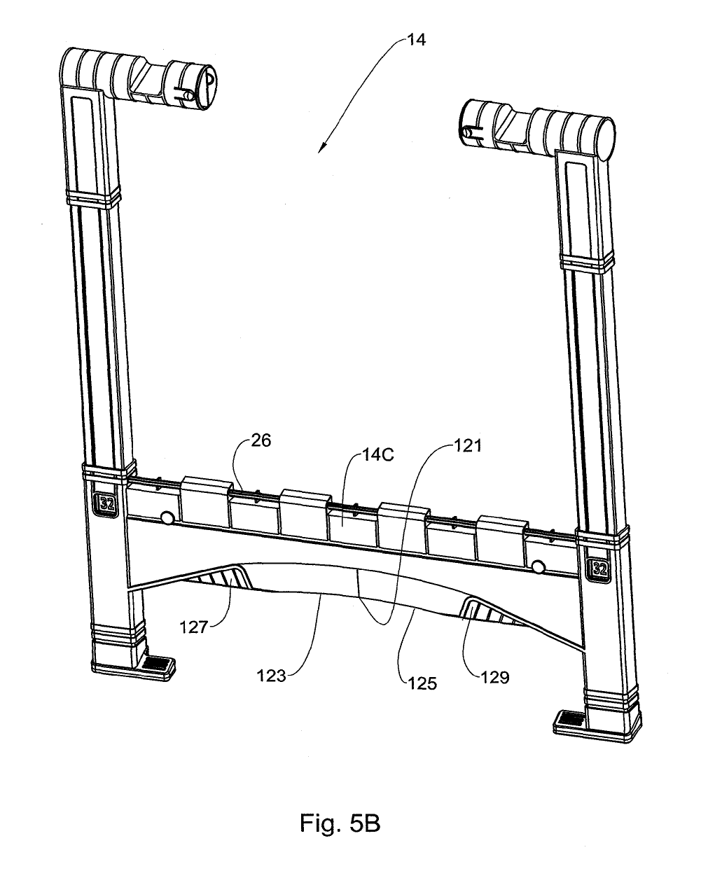

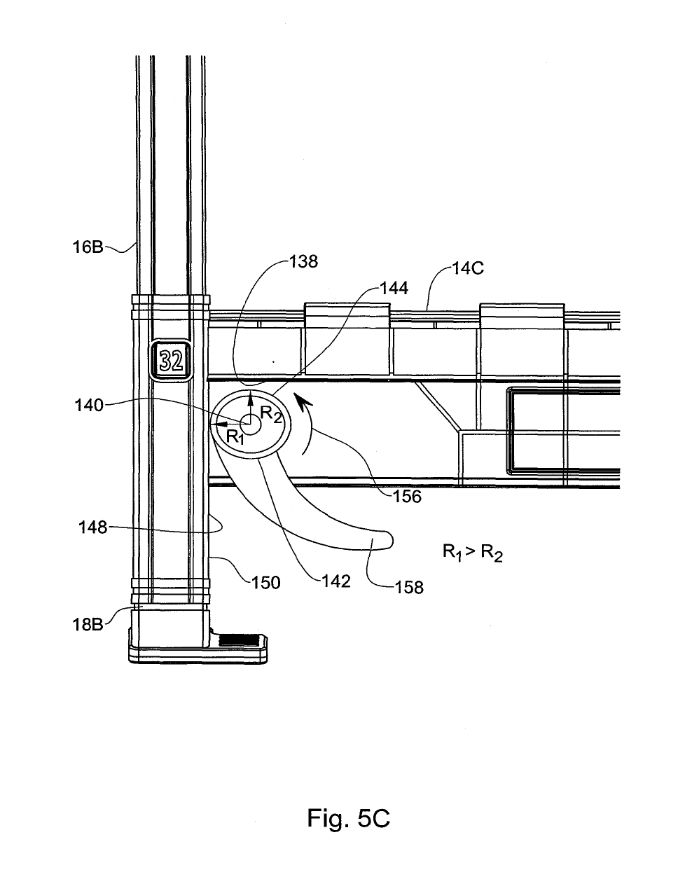

Each of the extendible legs comprises a locking mechanism generally designated 40 (FIGS. 2E and 5), configured for arresting each extension leg member 18A and 18B with respect to the respective support leg portions 16A and 16B. The locking mechanism 40 comprises a locking member in the configuration of a cogged strip 42 integral or integrated with the extension leg members and facing inwards (i.e. towards the second leg of a respective frame), said strip configured with a plurality of saw-teeth-like stopping locations 46 (FIG. 5A) and an arresting lever 48. The arresting lever 48 is received within the interconnecting support member 12C and 14C, pivotally secured therein about a pivot axis 52. The arresting lever 48 is configured with one or more arresting teeth 54 shaped and sized for engaging with teeth 46 of the cogged strip 42 (as displayed in the right portion of FIG. 5A). It is seen that when the arresting lever 48 is pivotally rotated in direction of arrow 54 about axis 52 (as in the left portion of FIG. 5A) the arresting teeth 54 of the arresting lever 48 are disengaged from the teeth 46 of the cogged strip 42, thus facilitating axial displacement of each extension leg member 18A and 18B in sliding retraction/extraction fashion with respect to the support leg portions 16A and 16B.

The arresting lever 48 is also configured with a biasing arrangement, which in the present example is a leaf spring 56 bearing against a surface 58 of the interconnecting support member 14C, so as to bias the arresting lever 48 into a normally locked position (as in the left portion of FIG. 5A). It is further seen (e.g. in FIGS. 2E and 2G) that the arresting lever 48 comprises a manipulation portion 60, exposed through cutout portion 61 of the interconnecting support member 14C, whereby manipulation of the arresting lever 48 into its unlocked position (as in the left portion of FIG. 5A) can be easily facilitated by an individual using his hand or leg.

Further seen in FIG. 2C, each of the legs is fitted at a bottommost portion thereof with a foot portion 66 having an anti-slip bottom surface 68 and a lateral projection 70 configured for assisting axial displacement of the extension leg member 18A and 18B, e.g. by an individual's leg pressing down on said lateral extension 70. The lateral projection 70 thus serves as a manipulating aid for applying an extraction force to the extension leg members 18A and 18B.

The extension leg members 18A and 18B are fitted with indicia (e.g. strip 72 imprinted with marks representing height or rate of extraction), wherein said indicia is visible through a window 76 formed at the interconnecting support members 12C and 14C, such that the extent of extraction of each leg is separately indicated.

As can further be seen in the drawings, best in FIGS. 4A to 4D, the first frame 12 is broader than the second frame 14, whereby the legs of the second frame extend within the legs of the first frame and wherein at the fully folded/collapsed state of the sawhorse 10, the legs of the second frame 14 at least partially overlap the legs of the first frame (indicated by OL in FIGS. 4C and 4D), whereby at a folded position, the sawhorse has a minimal packaging volume.

The sawhorse 10 is configured also with several utility portions for supporting a workspace and the like. For example, a flat topmost surface 80 or the first frame 12 used for supporting a board of material, etc., and a longitudinal V-notch 90 extending along the top portion 12A of the first frame 12, configured for supporting an elongate workpiece, and cutouts 96 also at the top portion 12A of the first frame 12, e.g. for articulating a vise or supporting a workpiece.

In use, the sawhorse 10 can be deployed into its open state and its height can be adjusted easily to a required height and level. For example, when the sawhorse 10 is placed over a flat, substantially horizontal surface, all four legs can assume the same height (actually the same rate of extrication of the extension leg members 18A and 18B). In FIGS. 1A and 1B the sawhorse 10 is illustrated with all four legs fully retracted and in FIGS. 6A and 6B the sawhorse 10 is illustrated with all four legs fully extracted, giving rise to a tall sawhorse. A stopper is provided to prevent unintentional withdrawal of the extension leg members 18A and 18B from the respective support leg portions 16A and 16B.

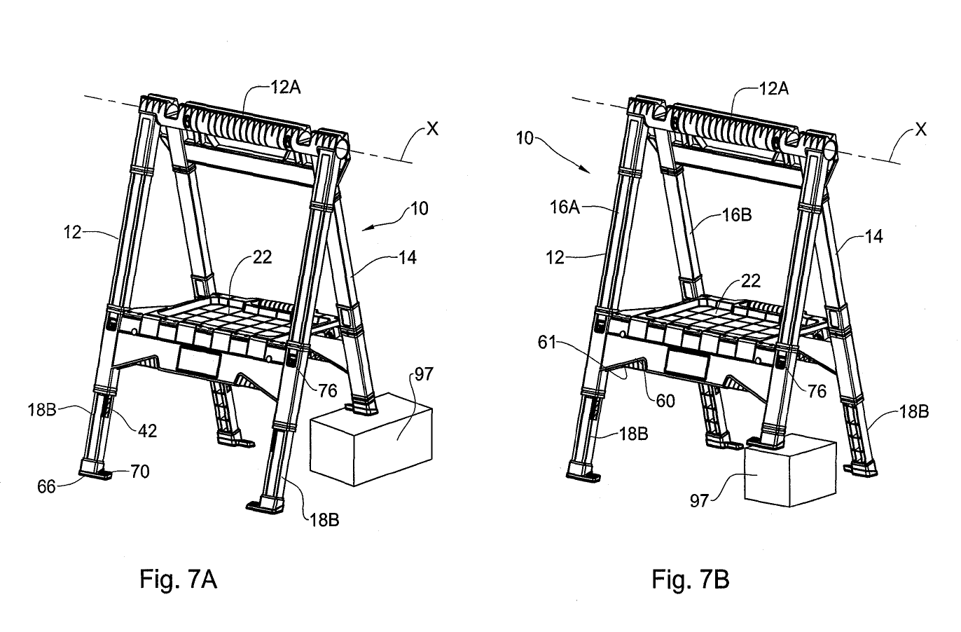

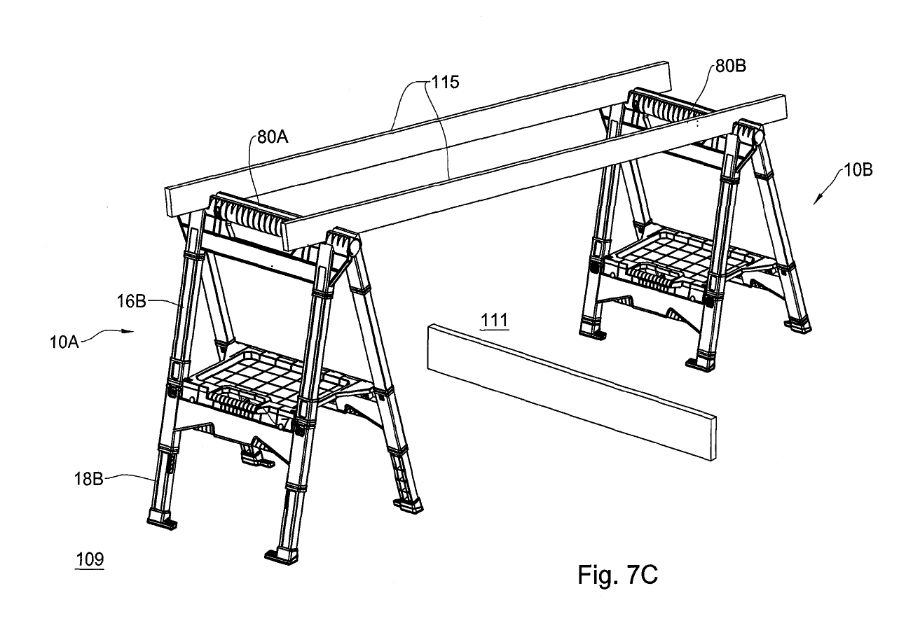

In FIGS. 7A and 7B, the sawhorse 10 is illustrated in a configuration in which three legs are evenly extracted and only one of the extension leg members 18A and 18B, respectively, is retracted so that the sawhorse can be positioned level albeit an obstacle (e.g. step 97). For effectively balancing the sawhorse, there is a bubble level 102 embedded at a top portion of the sawhorse (FIG. 2A).

In FIG. 7C, there is exemplified a pair of sawhorses according to the disclosure designated 10A and 10B, wherein sawhorse 10A is disposed over a horizontal flat surface 109 and the second sawhorse 10B is disposed over a horizontal flat surface 111 however elevated with respect to surface 109. Thus, all four extension leg members of the first sawhorse 12A are fully retracted whilst all four legs of the second sawhorse 10B are equally extracted, whereby the top surfaces 80A and 80B respectively are level and can bear beams 115 suitable for establishing a level work table, a scaffold, and the like.

Turning now to FIG. 5B there is illustrated a modification of the locking arrangement previously described. In the present example, the interconnecting support member 14C is configured with a central cutout portion 121 and the manipulating portions 123 and 125 of both left and right arresting levers 127 and 129, respectively, extend towards the center of the frame and are exposed at the central cutout portion 121. Thus, both arresting levers 127 and 129 can be simultaneously manipulated (e.g. by an individual using his hand or foot) to depress the manipulating portions 123 and 125 for unlocking engagement of the teeth 54 (not seen) from the cogged strip 42 (also not seen). However, it is appreciated that this configuration also facilitates manipulating each arresting lever individually and regardless of the position of a neighboring arresting lever.

In FIG. 5C, there is illustrated a locking mechanism according to a different example of the present disclosure, which however does not depart therefrom. In this example, rather than a geometrical engagement of the teeth 54 of the arresting lever with the teeth 46 of the respective extension leg member, there is provided an eccentric lock member generally designated 138 pivotally secured to the interconnecting support member 14C at 140. The eccentric lock member has a dial like locking ring 142 having an altering radii extending between a locking radii designated R₁ and a free radii designated R₂. Typically, a peripheral surface 144 of the locking ring 142 is knurled, and likewise, a locking surface 148 of the respective extension leg member 18B, is exposed through a widow 150 at the support leg portion 16A.

The arrangement is such that the extension leg member 18B is free to axially displace within the support leg portion 16A, (in particular in the extraction direction), as long as the locking ring 142 is in its unlocked position (upon rotating in direction of arrow 156), e.g. by manipulating of lever 158 thereof or under friction forces residing between the locking surface 148 and the peripheral surface 144. However, retraction of the extension leg member 18B can be facilitated only upon manipulating the lever 158 in direction of arrow 156.

The arrangements disclosed hereinabove offer a sawhorse in which extending one or more legs is easily facilitated using one's hands or a foot to depress the foot extension (lateral projection), whereby extraction of a respective leg does not require any manipulation of the locking mechanism. However, retracting a leg can be facilitated only upon manipulating and unlocking a respective locking mechanism. Even more so, it is appreciated that the extension leg members do not spontaneously extract owing to friction forces residing between a respective extension leg member and its support leg portion, as well as the biasing/friction force applied by the locking mechanism. For that purpose, the locking mechanism is configured as a one-way locking mechanism, wherein locking is spontaneous and unlocking thereof can be facilitated only upon manipulation thereof. Accordingly, when carrying the sawhorse (i.e. when the sawhorse is elevated from the ground) the legs will not spontaneously extract, but only upon applying an external force by the user (e.g. on the lateral projection of the extension leg member).

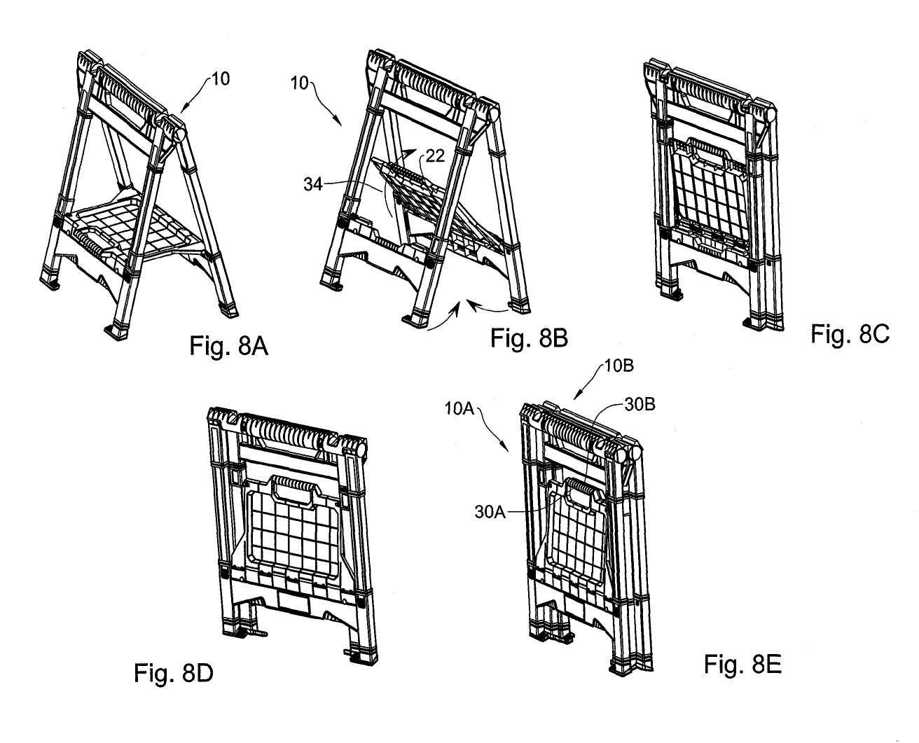

FIGS. 8A to 8D illustrate how a sawhorse 10 according to the disclosure is folded from a fully deployed, open position (FIG. 8A) by tilting shelf 22 upwards in direction of arrow 34 so that the frames 12 and 14 move near each other (FIG. 8B) until they reach a fully closed position (FIG. 8D) wherein the frames partially overlap as discussed hereinbefore. When two or more sawhorses 10A and 10B are positioned adjacent one another at their fully collapsed position (FIG. 8E), their handles 30A and 30B extend in close proximity, facilitating easy carrying of the two sawhorses.

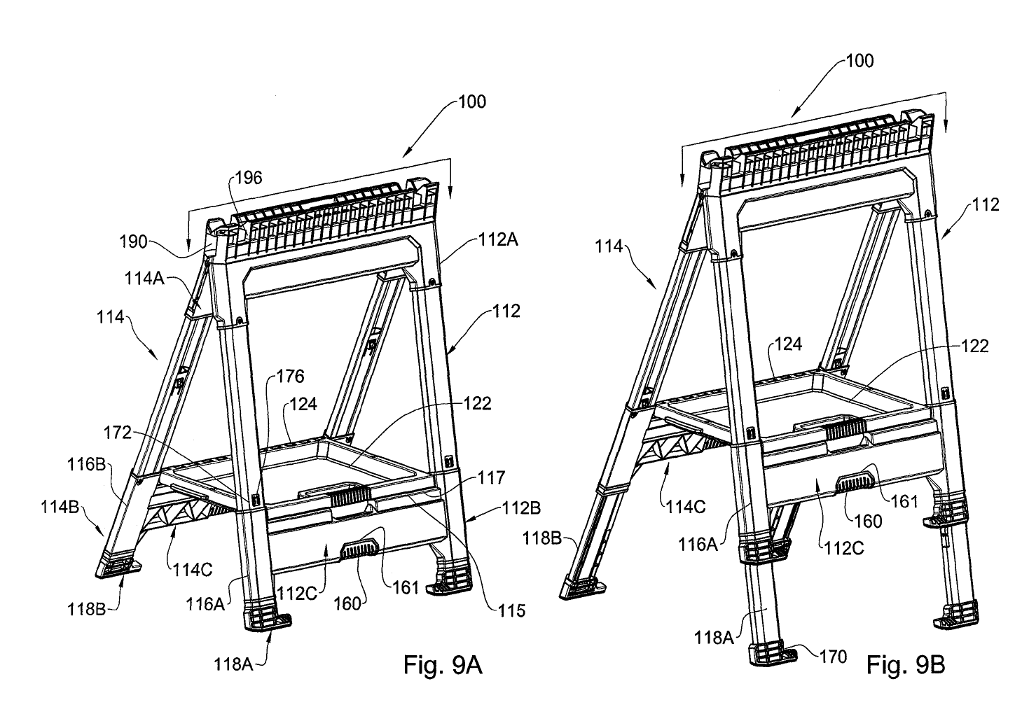

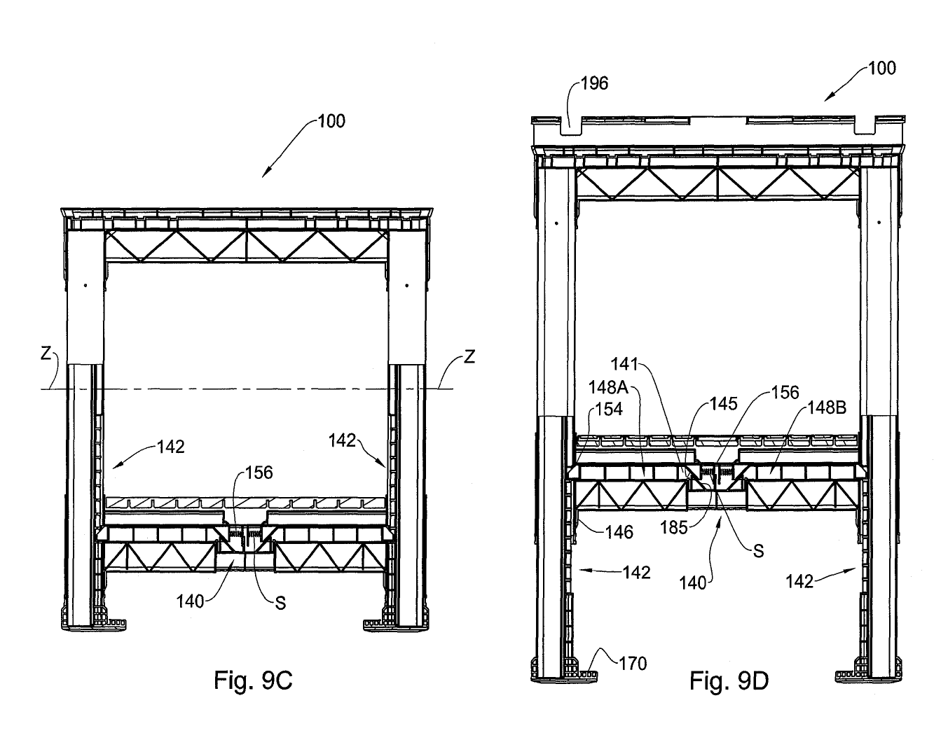

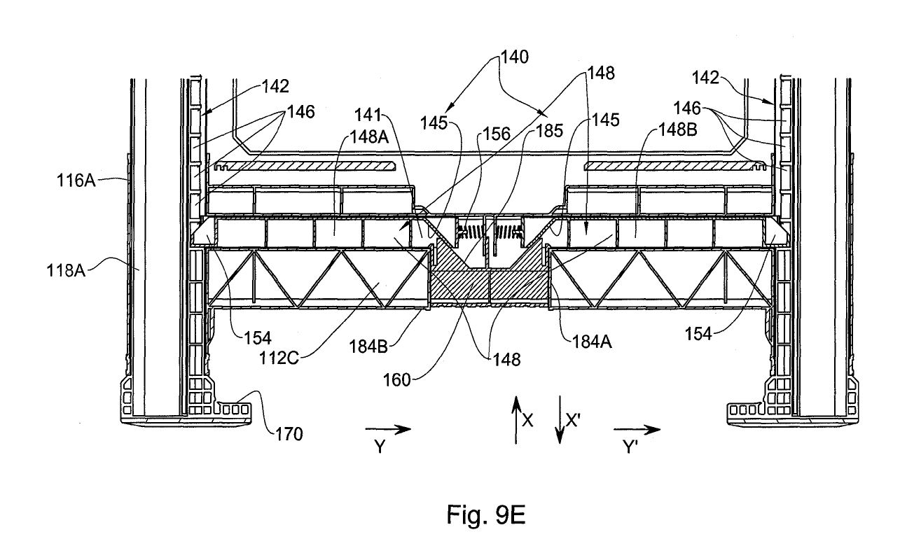

Attention is now directed to FIGS. 9A to 9E illustrating a sawhorse in accordance with another example of the disclosed subject matter and generally designated 100. Elements having a similar function as in the previously discussed example will be marked by the same numerals, upped by 100. One of the differences between the sawhorse of this example in comparison to the previously discussed examples is in the mechanism allowing for the leg adjustment. It will be appreciated that the described mechanism with respect to this example can be applied to the previously disclosed sawhorse or any other sawhorse having the feature or height adjustment.

The sawhorse 100 is composed of a first frame 112 and a second frame 114 pivotally articulated to one another at their top, as was discussed hereinabove.

Each frame comprises a top portion 112A and 114A respectively, a pair of legs 112B and 114B, and interconnecting support member 112C and 114C. Each leg 112B and 114B is configured with a support leg portion 116A and 116B and an extension leg member 118A and 118B, respectively. The arrangement is such that the support leg portions 116A and 116B and the extension leg members 118A and 118B have a corresponding cross-section and are thus configured for snug coaxial displacement, in this example having a substantially rectangle cross-section although it will be appreciated that other geometrical shapes are envisioned, provided the support leg member and the extension leg member are configured for a coaxial displacement (i.e. retraction/extraction between a fully retracted position as in FIG. 9A, and a fully extracted position as in FIG. 9B). It is however appreciated that the legs can be telescopic and further, each extension leg member 118A and 118B is independently axially displaceable with respect to the respective support leg portions 116A and 116B.

The sawhorse 100 is further configured with a collapsible shelf 122 resembling the shelf 22 discussed hereinabove.

As in the previously discussed examples, each of the legs is fitted at a bottommost portion thereof with a foot portion 166 and a lateral projection 170 configured for assisting axial displacement of the extension leg members 118A and 118B, e.g. by individual's leg pressing down on said lateral extension 170 while either holding the sawhorse in a elevated position or, for example, when the sawhorse is positioned on an uneven surface presenting the need to extend one or more of the leg members. The lateral projection 170 thus serves as a manipulating aid for applying extraction force to the extension leg members 118A and 118B. It will be appreciated that the extension leg members can be provided with an internal halting mechanism to ensure that the extension members are not fully removed from their respective engagement in their respective leg portions (not shown).

Each of the extendible legs is associated with a locking mechanism generally designated 140 (best seen in the enlarged view presented in FIG. 9E) comprising a locking member 142 and an arresting bolt member 148, together configured for arresting the extension leg members 118A and 118B with respect to the respective support leg portions 116A and 116B. The locking mechanism 140 comprises locking member in the form of a compartmentalized strip 142 integral or integrated with each of the extension leg members 118A and 118B extending vertically to the surface/ground when the sawhorse is in its operative configuration and facing inwards (i.e. towards the opposite leg of a respective frame). Each locking member in this example 142 is configured with a plurality of plate like stopping locations 146 (FIG. 9E). It will be appreciated that the locking member 142 can be of a different configuration, e.g. cogged strip, a strip with ratchet like teeth, etc. An arresting bolt member 148 for the locking mechanisms on both extension members is coaxially received within the interconnecting support member 112C and the two bolt members 148A and 148B are connected to each other through a biasing arrangement 156. The arresting bolt members are configured for axial displacement along the axis Z (seen in FIG. 9C).

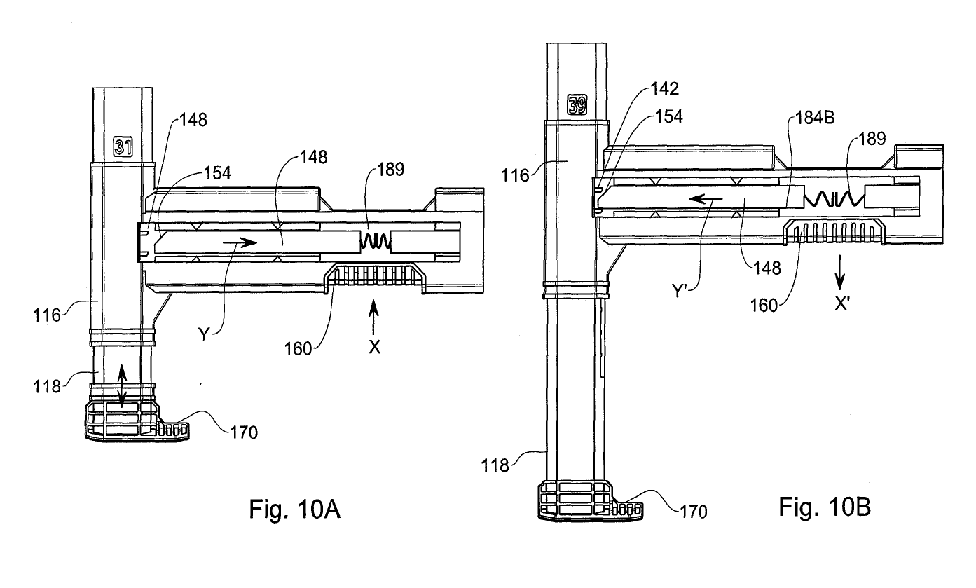

Although in the present disclosed subject matter the biasing member is a spring S extending between the inner edges of the bolt members thereby interconnecting these, it will be appreciated that other types of biasing members are envisioned, e.g. an integrally formed, flexible bellows/accordion like element (189 in FIGS. 10A and 10B) which is configured to contract and biased to expand. This latter type of biasing member in the form of an accordion-like strip (illustrated in FIGS. 10A and 10B which illustrate the operation of the locking mechanism), is in this example injection molded along with the arresting levers 148A and 148B, such that the strip comprises thinned out sections where it folds to form the accordion like fold for the biasing member. Thus the arresting levers and the respective biasing members can be integrally molded as a unitary element. This can help for example in reductions of assembly costs, in preventing rust which might develop in other types of biasing members such as metal springs, etc.

The lever 148 in accordance with this example has a locking end 154 configured to be latched within the locking member 142, e.g. the compartments of the compartmentalized strip, i.e. to rest over the plates 146. The locking end can be a ratchet-tooth like edge (in the example illustrated in FIGS. 9A to 10B, the corner of ratchet tooth is chamfered (at about 45 degrees) at its top side, facing the upper utility portion of the sawhorse, but it will be appreciated that the tooth can be devoid of such a cut, which will prevent its ratchet like function, requiring manipulation of the locking mechanism to release the lever from the arresting/locking member 142).

FIGS. 9C to 9E illustrate the locking mechanism in a cross section in accordance with an example of the disclosed subject matter. In the present example the interconnecting support member 112C/114C is configured with a central cutout portion 161 about the center of the support configured to receive a central manipulating member 160 (also referred to interchangeably as release mechanism) provided with upwardly (i.e. facing in the general direction of the utility portion of the sawhorse) extending extensions 184A and 184B configured to engage the levers 148A and 148B at the end associated with the biasing member. The levers in this example are each provided with an opening 141 adapted in size and shape to snugly receive the respective extension 184 when maneuvered as will be discussed in detail with reference to FIGS. 10A and 10B. Thus the manipulating element is associated with the respective lever member to actuate the locking mechanism and release the lever from the respective locking member.

The engagement between the extensions 184A and 184B and the bolt members 148A and 148B is such that by manipulating the member 160 by pressing in the direction of arrow X in FIGS. 9E and 10A, the extensions 184A and 184B having in this example a ratchet-like tooth with a slanted wall 145 at its inner side (i.e. facing the corresponding slanted wall 185 of the respective extension) is configured to engage the slanted wall 145 of the bolt member so as to facilitate sliding of the respective extension 184 into the respective opening 141 in the bolt member 148, thereby pulling it in the direction of arrow Y, which is perpendicular to the direction of arrow X in which direction the member 160 is pressed. When pressing the central manipulating member 160, both arresting bolt members 148A and 148B can be simultaneously manipulated (e.g. by an individual using his hand or a foot/leg) to press the manipulating portions 184A and 184B for unlocking engagement of the end 154 (seen in FIG. 10A in the unlocked position) from the strip 142 and biasing the spring S or the biasing member 189 such that when the manipulation member is released (moving downwards in the direction of arrow x′), the bolt members are biased to extend in opposite directions (marked by arrow y′) until engaging the respective locking mechanism 142 at the desired position and height of the extension leg members 118.

The arrangements disclosed hereinabove offer a sawhorse in which extending/retracting one or more legs and adjusting the height of its leg members is facilitated by using one's single hand/foot to press over the manipulating member 160, whereby in accordance with this example, due to the ratchet like tooth configuration of the bolt member end the extraction of a respective extension member, does not require any manipulation of the locking mechanism as it is a ratchet-type locking arrangement. It will be appreciated that the extraction does not depend on the sawhorse being in its deployed or collapsed positions.

In accordance with an example, retracting the extension member can be facilitated only upon manipulating and unlocking a respective locking mechanism. Even more so, it is appreciated that the extension members do not spontaneously extract, e.g. when pressed down or tilted, owing to friction forces residing between a respective extension member and its leg members, as well as the biasing/friction force applied by the locking mechanism. For that purpose, the locking arrangement in accordance with this example is configured as a one-way locking mechanism, wherein locking can be spontaneous and unlocking thereof can be facilitated only upon manipulation thereof.

Although discussed above, the attention is drawn to FIGS. 10A and 10B which illustrate the locking arrangement mechanism in a partially cut out view and in operation. FIG. 10A illustrates the mechanism with the central manipulating member 160 in a pressed configuration (in the direction of arrow x), which in turn engages the bolt member by biasing the accordion-like biasing spring 189, thus releasing the end 154 of the bolt member from the locking member 142 by moving the bolt member 148 in the direction of arrow y. this will allow the manipulation of the extension member 118 in a vertical direction marked by the two headed arrow A. FIG. 10B illustrates the leg extensions 118 in the extended configuration upon release of the central manipulating member 160 (which moves in the direction x′, opposite the direction of arrow x) thus releasing the bolt member 148.

1. A sawhorse, comprising:
two rigid frame members pivotally articulated to one another, each frame member comprising two legs,
at least one leg of each frame member being an extendible leg comprising a support leg portion, an extension member coaxially extending therewithin and a locking mechanism actuatable by one or more manipulation member, the extension member being displaceable between a fully retracted position and a fully extracted position,
wherein extraction of the extension member is facilitated without requiring manipulation of the manipulation member configured for actuating the locking mechanism while the retraction displacement of the extension member is facilitated only upon manipulating the manipulation member to actuate the locking mechanism to thereby allow retraction of the extension member into the support leg portion.

2. The sawhorse according to claim 1, wherein the locking mechanism is configured such that the gravity force acting on the extension member is lesser than friction forces extending between the extension member and the support leg portion, including such forces resulting from the locking mechanism such that the extension member is prevented for spontaneously displacing into extracted configuration, unless an external force is applied in an extraction direction.

3. The sawhorse according to claim 1, wherein the locking mechanism comprises at least one locking member associated with the respective extendible leg and a locking lever or a bolt configured to engage the locking member.

4. The sawhorse according to claim 1, wherein the locking mechanism comprises a ratchet type locking mechanism.

5. The sawhorse according to claim 1, wherein all legs of the sawhorse can be configured with an extendible leg.

6. The sawhorse according to claim 1, wherein extraction displacement of an extension member is facilitated spontaneously.

7. The sawhorse according to claim 1, wherein the extendible leg is telescopic, and wherein the extension member is coaxially displaceable with respect to a support leg portion of the frame.

8. The sawhorse according to claim 2, wherein the external force is a pulling force applied to the extension member in said extraction direction.

9. The sawhorse according to claim 1, wherein the locking mechanism is an eccentric/cam type lock.

10. The sawhorse according to claim 1, wherein the locking mechanism is configured with a biasing mechanism for retaining the locking mechanism at a normally locked position.

11. The sawhorse according to claim 9, wherein the biasing mechanism is integrally formed with at least a portion of the locking mechanism.

12. The sawhorse according to claim 9, wherein the biasing mechanism is a biasing spring configured to contract and biased to expand.

13. The sawhorse according to claim 1, wherein the locking mechanism comprises a lever or a bolt member associated with a locking member provided over each of the extendable legs and wherein the two legs of at least one of the frame members are extendible legs having a locking mechanism actuatable by a common manipulating member.

14. The sawhorse according to claim 13, wherein the two levers or bolt members associated with the locking members of the two extendable legs are configured with a biasing mechanism for retaining the locking mechanism at a normally locked position.

15. The sawhorse according to claim 1, wherein the extendible legs can be configured with indicia for indicating the extent of axial displacement of the extension member with respect to the support leg portion.

16. The sawhorse according to claim 1, further comprising one or more shelves articulated to the frames and disposable between a collapsed/folded position, at which the one or more shelves are substantially stowed between the folded frames, and an open position at which the one or more shelves are disposed substantially horizontally between the two frames.

17. The sawhorse according to claim 15, wherein at least one of the shelves is configured with one or more carrying handles configured for carrying the sawhorse at its folded position.

18. The sawhorse according to claim 1, wherein the frames are configured as I-like frames with or without an interconnecting top portion facilitating pivotal articulation of the two frames to one another.

19. The sawhorse according to claim 1, wherein the bottom ends of the frame legs are configured with a floor engaging members comprising a puling foot portion.

20. The sawhorse according to claim 1, wherein the pivotal articulation of the top portions of the two frame members can be facilitated by a first frame member configured with a tubular receptacle coaxially receiving therein a corresponding pivoting segment of the second frame member, said pivoting segment configured for snug rotation within the tubular receptacle.
